(19) United States
(12) Patent Application Publication
(10) Pub. No.: US 2005/0172741 A1
(43) Pub. Date: Aug. 11, 2005

(54) Drive device

(75) Inventor: Nicolaas Van Der Plas, Oldenzaal (NL)

Correspondence Address: DARBY & DARBY P.C., P. O. BOX 5257, NEW YORK, NY, 10150-5257, US

(73) Assignee: Trioliet Mullos B.V., Oldenzaal (NL)

(21) Appl. No.: 11/041,083

(22) Filed: Jan. 21, 2005

(30) Foreign Application Priority Data
Feb. 6, 2004 (DE) 20 2004 001 818.7

(51) Int. Cl. F16H 3/08; F16H 59/00

(52) U.S. Cl. 74/336 R; 74/337

(57) ABSTRACT

A drive device (9, 29, 39, 49, 59), in particular for a mixing tool (5) of a food mixer (1), is described, which comprises a gear having an input shaft (11), an output shaft (12), gear members for driving the output shaft (12) with a low and at least one higher speed as well as a shifting device (19, 34, 57, 60) for shifting between the speeds. In order to design such a drive device in a structural simple manner, such that peak powers in the starting step are handled, it is proposed that for a starting operation, a starting step (A) with a low speed is designed, wherein the starting step contains an overrunning clutch (16) via which a gear member (14) can be connected in the starting step with the input and output shafts (11, 12) with transmission of motion, and which can be released at the higher speed.

The invention relates to a drive device of the type explained in the preamble of claim 1.

Such a drive device is known from DE 201 19 534 U1. The known drive device serves for driving a mixing screw of a food mixer by the power take-off shaft of a tractor. Between the power take-off shaft and the mixing screw, a gear and a clutch device are disposed via which the mixing screw can be driven at various speeds, wherein the shifting can be effected in operation. In mixing screws in food mixers and also in other comparable devices, there is a problem that, depending on the mixing task, different performance requirements are placed on the drive device, increased performance requirements mainly occurring when the work is started. In food mixers, these increased performance requirements result, for example, from the stickier or harder consistency of the food at the beginning of the mixing operation or from the fact that in particularly large mixers (more than 30 m³), the food has to be first started to move. In order to take into account these increased loads, in the known drive device, there is a possibility of automatically shifting down to a lower speed if the torque is inadmissibly increased, and if the load normalizes, it is automatically shifted again to the higher speed. To this end, the known drive device contains a measuring device for measuring the driving torque for the mixing work of the mixing screw and a controlling means which correspondingly shifts the gear. This, however, does not necessarily solve the problem, as the increased torques have to occur before the controlling means reacts and can shift down. This can be a problem in particular during the start.

Therefore, the object underlying the invention is to improve the start behavior of a drive device.

The starting step provided according to the invention ensures that a mixing or other tool or apparatus always starts at a speed that is also able to provide high performance. In this manner, it is ensured that first the driven structure starts to move before a shifting to a higher speed is effected. The starting step furthermore permits to shift to the next higher speed in operation, as the clutch device only has to shift a relatively small torque as the gear already rotates and the higher torque does not have to be generated from a standstill. If a motor is used for the shifting operation, only a small speed range is necessary. With respect to construction and function, the use of an overrunning clutch is the simplest and best possibility of ending the starting step if a shifting to a higher speed is effected.

Advantageous further developments of the invention can be taken from the subclaims.

If the overrunning clutch is released by rotating the output shaft, no additional arrangements for releasing the overrunning clutch at the end of the starting operation have to be provided.

If the drive is accomplished, for example, by means of the power take-off shaft of a tractor, it is particularly advantageous for the clutch to be directly connectable to the output shaft.

A gear limitation device prevents a too fast shifting to the higher speed.

A gear limitation independent of the tractor can be realized with a hydraulic pump and a proportional valve of the gear limitation device.

The invention can be employed in many diverse types of gears. In the simplest case, the gear only consists of one gear step with a higher speed in addition to the starting step. However, a plurality of gear steps can also be provided, in which case both gear steps release the overrunning clutch.

The drive device according to the invention can also be designed as a continuously variable transmission with an additional starting step.

It is preferred to use a chain converter for the continuously variable gear range, which can be preferably separated from the drive via an overrunning clutch in the starting step.

However, for a continuously variable gear range, a differential gear can also be used.

By using the drive device according to the invention as a reduction gear which is arranged upstream of a common drive shaft of a plurality of mixing screws, the angular gears for driving the individual mixing screws can have a simple construction. Due to the starting step, the drive device according to the invention can easily start to move the plurality of mixing screws even of large food mixers even against a high resistance of the filled in food.

In the following, embodiments of the invention are illustrated more in detail with reference to the drawings. In the drawings:

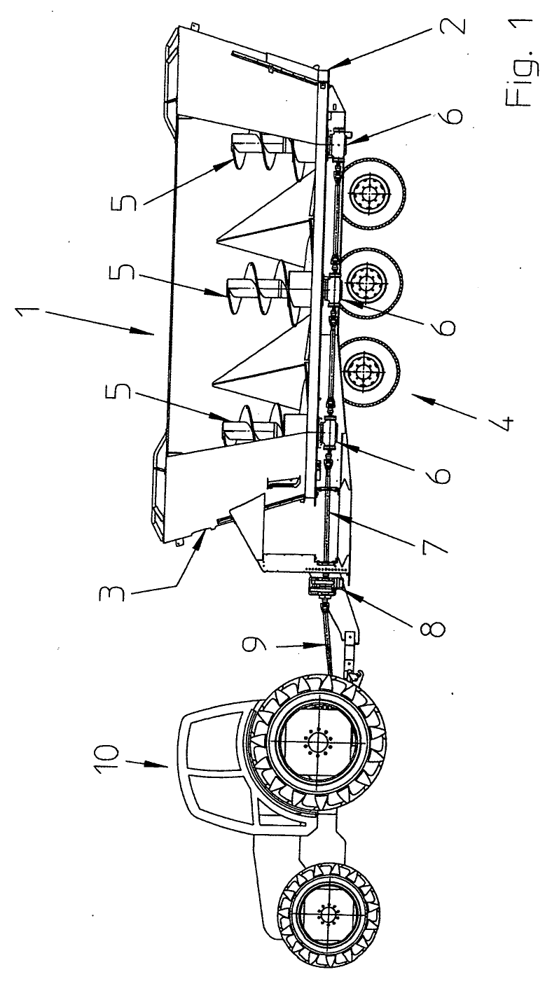

FIG. 1 shows a food mixer equipped according to the invention in a schematic representation in a side view,

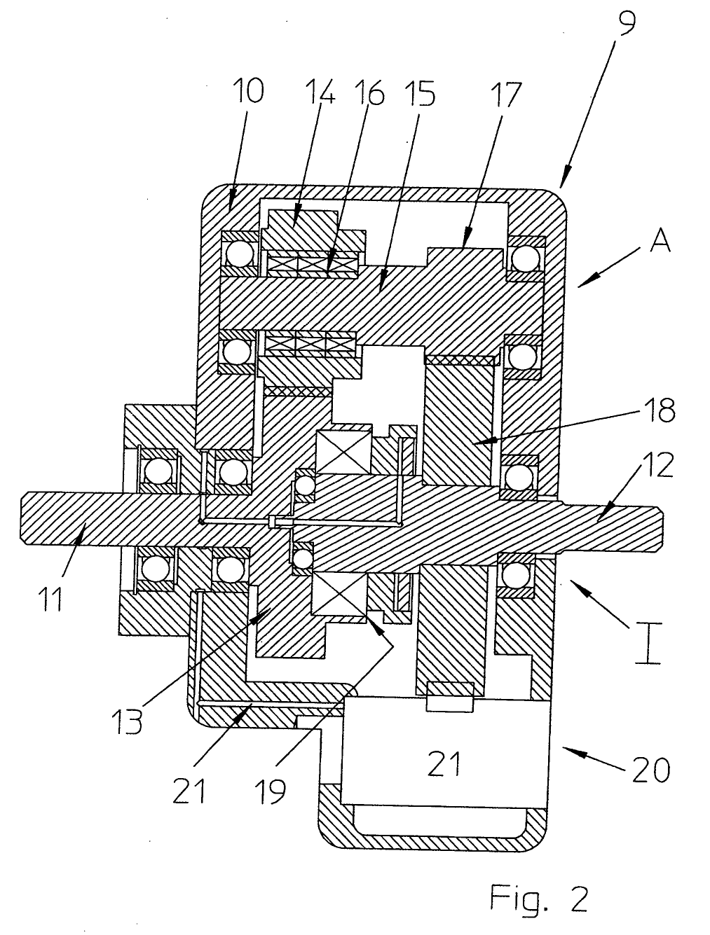

FIG. 2 shows a sectional schematic representation of a first embodiment of a drive device according to the invention,

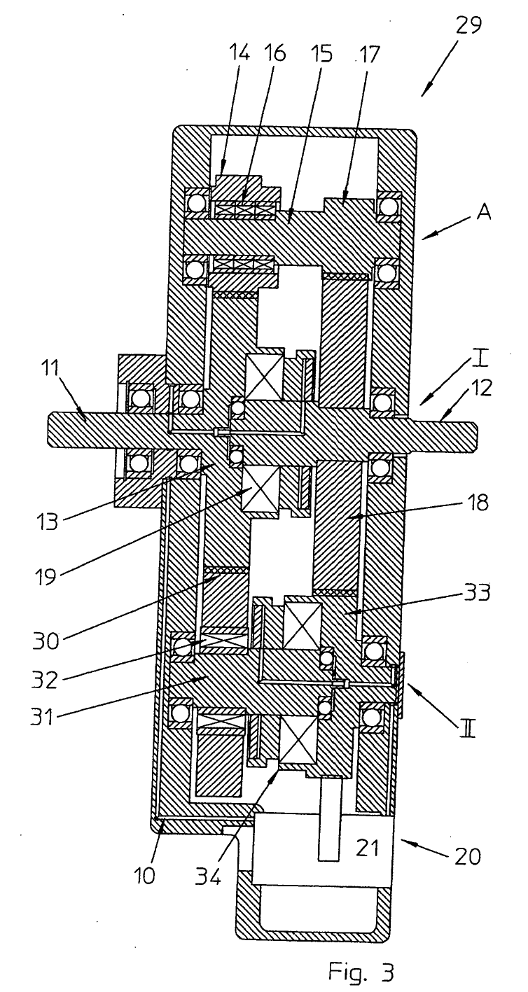

FIG. 3 shows a sectional schematic representation of a second embodiment of a drive device according to the invention,

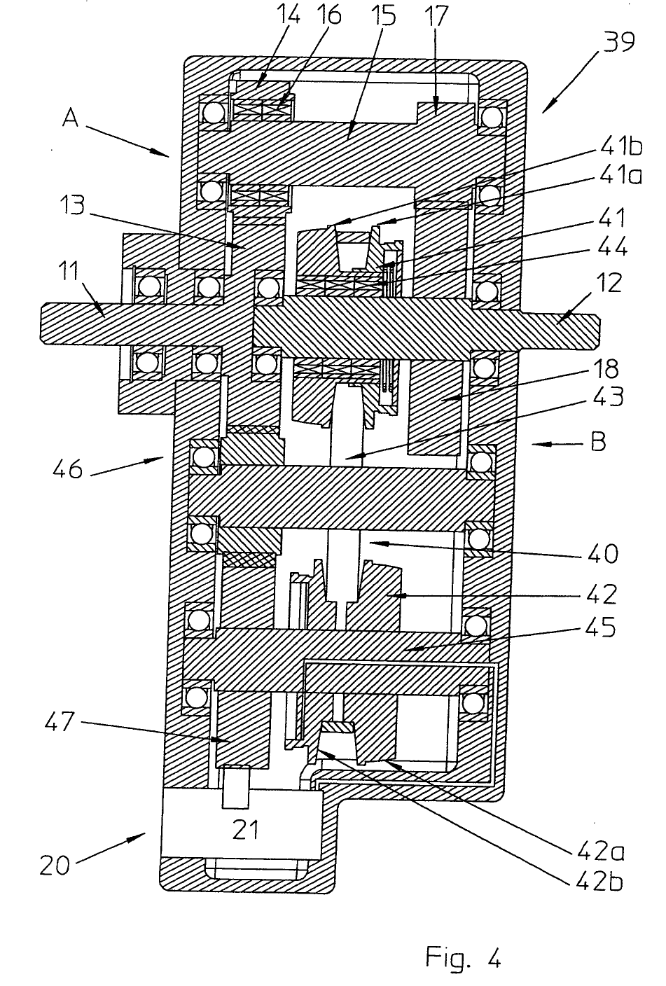

FIG. 4 shows a sectional schematic representation of a third embodiment of the drive device according to the invention,

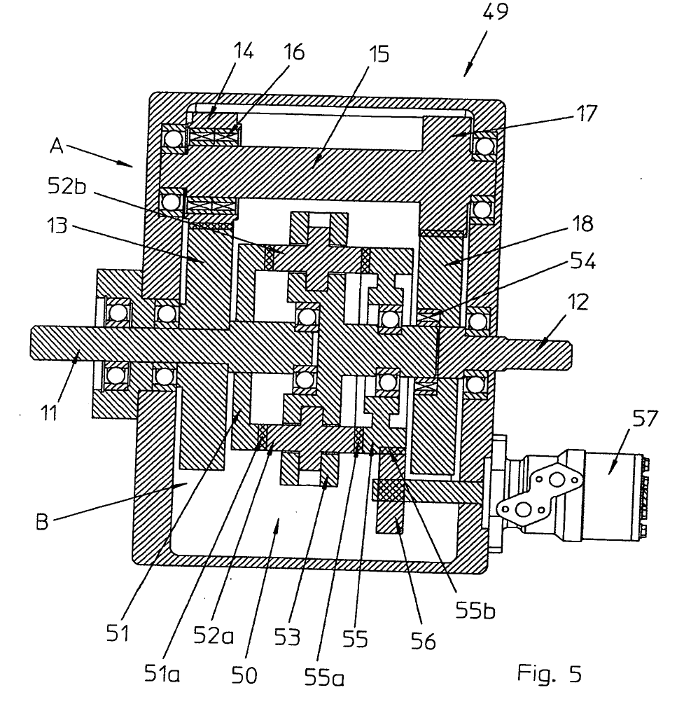

FIG. 5 shows a sectional schematic representation of a fourth embodiment of a drive device according to the invention, and

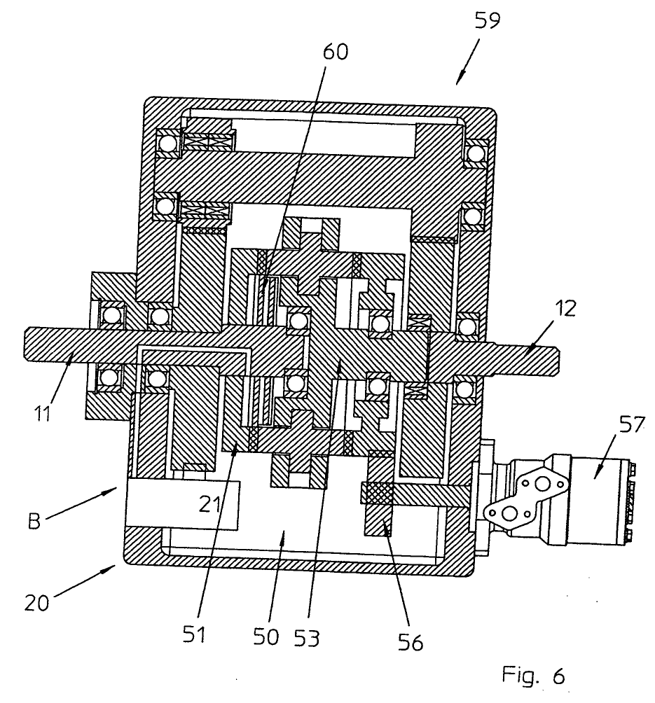

FIG. 6 shows a sectional schematic representation of a fifth embodiment of a drive device according to the invention.

FIG. 1 shows a schematic representation of a food mixer 1 designed as a mixing car in the shown embodiment. The food mixer 1 contains a frame 2 with a container 3 movable via a running gear 4. In the shown embodiment, three mixing tools 5 are provided in the interior of the container 3 which are designed as vertical mixing screws in the shown embodiment. Each of the mixing screws 5 is driven by one common drive shaft 7 each via an angular gear 6. The drive shaft 7 is driven by a power take-off shaft 9 of a tractor 10 via a drive device in the form of a reduction gear 8. The reduction gear 8 contains a plurality of gear members effecting a gear reduction of the speed of the power take-off shaft 9, such that the drive shaft 7 and thus the mixing tools 5 can be driven at different speeds.

The details described so far correspond to the constructive design of conventional food mixers and accordingly do not have to be explained again in detail.

One of the drive devices represented in FIGS. 2 to 4 can be employed as reduction gear 8.

FIG. 2 shows a first embodiment of a drive device 9 designed according to the invention in the form of a pure cylindrical gear. The drive device 9 comprises a housing 10 in which an input shaft 11 and an output shaft 12 are mounted. In the shown embodiment, the input shaft 11 is arranged coaxially with the output shaft 12. When it is used as a reduction gear 8 in FIG. 1, the input shaft 11 is connected with the power take-off shaft 9 and the output shaft 12 is connected with the drive shaft 7.

The drive device 9 is an engaging and disengaging multi-step reduction gear with gear members in the form of gearwheels and contains a first gear step A designed as starting step for a starting operation and it provides a gear reduction of the higher speed of the input shaft 11 to a lower speed at the output shaft 12. The drive device 9 furthermore contains a gear step I which provides a higher speed at the output shaft 12, as it is, for example, convenient and common for mixing and discharging food. In the represented embodiment, the gear step I permits a direct drive of the output shaft 12 at the speed of the input shaft 11.

The drive device 9 contains a first gearwheel 13 which is designed as spur gear and is fixed to the input shaft 11. The first gearwheel 13 meshes with a second gearwheel 14 having a smaller diameter with respect to the first gearwheel 13, is seated on a bypass shaft 15 mounted in the housing 10 and is provided with an overrunning clutch 16. The overrunning clutch 16 permits a drive transmission from the first gearwheel 13 via the second gearwheel 14 to the bypass shaft 15 and is preferably designed as an overrunning clutch comprising clamp bodies.

The bypass shaft 15 contains a third gearwheel 17 which is stationarily seated on the shaft 15 and the diameter of which is preferably smaller than that of the second gearwheel 14. The third gearwheel 17 meshes with a fourth gearwheel 18 which is fixed on the output shaft 12. The gearwheel 18 has a diameter which is preferably larger than that of the third gearwheel 17 and that of the first gearwheel 13. However, the third gearwheel 17 could be as large as the second gearwheel 14 and the fourth gearwheel 18 could be as large as the first gearwheel 13.

A clutch 19 is provided between the output shaft 12 and the input shaft 11, which clutch is preferably actuated hydraulically and connects the output shaft 11 directly to the input shaft 11 when it is engaged, while in the released state of the clutch 19, the input shaft 11 and the output shaft 12 can rotate independently of one another. The clutch is preferably a hydraulic multi-plate clutch with a very small volume of, for example, 20 cm³, which clutches from approx. 20 bar, however, it can also be any other synchronized, mechanical or electric clutch.

In the housing 10, moreover a gear limitation device 20 which acts on the hydraulic circuit for actuating the clutch 19 is arranged. The gear limitation device 20 serves for shifting to the first gear step I independently of the hydraulic circuit of the tractor and only via the starting step A. The control of the clutch, however, could also be effected via the tractor (ISOBUS system).

The gear limitation device 20 contains a gear pump 21 which is driven in the starting step A in particular via the fourth gearwheel 18 and builds up a medium hydraulic pressure by means of this drive. The gear limitation device furthermore contains a non-depicted proportional valve which determines the pressure of the hydraulic fluid the pump 21 has to raise, so that the clutch 19 can be shifted by the driver or automatically.

The drive device 9 works as follows. If the drive is switched on via the power take-off shaft 9, first the input shaft 11 with the first gearwheel 13 rotates while the proportional valve blocks an engagement of the hydraulic clutch 19 (pump without pressure). It thus cannot be shifted. Thus, the drive is operated via the starting step A, i.e. the first gearwheel 13 drives the second gearwheel 14, the gearwheel 14 and the overrunning clutch 16 drive the bypass shaft 15 and the third gearwheel 17, and the third gearwheel 17 drives the fourth gearwheel 18 and the output shaft 12. The output shaft 12 then drives the mixing tools 5 via the angular gears 6 at a very low speed and an accordingly high torque.

At the same time, however, the gear pump 21 of the gear limitation device 20 is also driven by the fourth gearwheel 18, which increases the pressure of the hydraulic fluid and permits a shifting of the hydraulic clutch 19.

If the clutch 19 is shifted by the driver or automatically, in the gear step I, the fourth gearwheel 18 is directly driven by the input shaft 11, this time at a higher speed than via the starting step A. The fourth gearwheel 18 now drives the third gearwheel 17 and thus the bypass shaft 15 in a reverse direction of transmission, i.e. in a direction back to the input shaft 11, the bypass shaft 15 now rotating faster than the second gearwheel 14 which is, as before, driven by the first gearwheel 13. Thereby, the overrunning clutch 16 is released and separates the drive train via the starting step A.

If the input shaft 11 stands still, the gear pump 21 is neither driven any longer and the pressure falls to zero, so that in another starting operation, the drive is again first effected via the starting step A.

The drive device 9 is particularly suited for mixing devices up to approx. 25 m³, i.e. medium to large mixing cars. In the starting step A and in the mixing operation, a step-down ratio of approx. 1.7:1 is used, during the metering out operation, a ratio of 1:1 is used.

The drive device 9 according to FIG. 2 can be expanded by one or several further gear steps, FIG. 3 showing an embodiment of a drive device 29 in which the starting step A and the gear step I of the embodiment according to FIG. 2, and in addition a further gear step II are provided. The structural design of the starting step A and the gear step I correspond to the embodiment according to FIG. 2 and are provided with the same reference numerals and not explained again. In the starting step A, however, a gear reduction in the range of about 3.5-4.0:1 is realized, and in the gear step I, a ratio of 1:1 is again realized. The gear step II is also a gear step with a higher speed (transmission ratio about 1.7:1), its speed, however, is between that of the starting step A and the gear step I; it thus delivers a speed at the output shaft 12 which is higher than in the starting step A, but lower than in the gear step I, so that one can select between a lower speed in the gear step II, as it can be employed, for example, for mixing, and a higher speed in the gear step I, as it can be used, for example, for discharging the food from the container 3. Here, with an input speed of 1000 rpm, the speeds during the starting operation are 250-300 rpm, during the mixing operation 500-650 rpm, and during the metering out operation up to 1000 rpm.

The gear step II is also designed as cylindrical gear and contains a fifth gearwheel 30 which is seated on a bypass shaft 31 which is mounted in the housing 10 and meshes with the first gearwheel 13. Preferably, between the fifth gearwheel 30 and the bypass shaft 31, a second overrunning clutch 32 is provided, which, however, is not absolutely necessary, as described below.

The fourth gearwheel 18 meshes with a sixth gearwheel 33 which is also rotatably mounted in the housing 10. The sixth gearwheel 33 is mounted coaxially with the axis of the second bypass shaft 31 and can be connected with the second bypass shaft 31 by means of a clutch 34, preferably a hydraulic clutch, with transmission of motion.

The fifth gearwheel 30 is preferably relatively small with respect to the first gearwheel 13 and smaller than the sixth gearwheel 33, while the sixth gearwheel 33 is small with respect to the fourth gearwheel 18 and the fourth gearwheel 18 is larger than the first gearwheel 13. Therefore, a preferably low torque has to be shifted by the clutch.

The drive device 29, too, contains the gear limitation device 20 with the gear pump 21, which in this case, however, is driven via the sixth gearwheel 33 for reasons of design. The gear limitation device 20 acts on the clutch 34 in this embodiment and prevents the engagement of the clutch 34 as long as the necessary pressure has not been built up via the starting step A.

If the necessary pressure is built up by the gear pump 21, the clutch 34 can be shifted. If the clutch 34 is shifted, the first gearwheel 13 drives the fifth gearwheel 30, and with a connected overrunning clutch 32, the bypass shaft 31 drives the sixth gearwheel 33, and the same drives the fourth gearwheel 18 and thus the output shaft 12. The fourth gearwheel 18, however, also rotates the third gearwheel 17 and the bypass shaft 15 of the starting step A, so that the overrunning clutch 16 is released.

If the speed is to be further increased, the first clutch 19 is shifted. If there is a second overrunning clutch 32, the hydraulic clutch 34 of the gear step II can remain engaged. Then, the drive of the output shaft 12 is directly effected by the input shaft 11, while the first gearwheel 13 drives the fifth gearwheel 30 and the fourth gearwheel 18 drives the sixth gearwheel 33, which either leads to a release of the overrunning clutch 32 if the hydraulic clutch 34 is engaged, so that thereby the described driving motion is possible, or else the second hydraulic clutch 34 is released which makes the second overrunning clutch 32 superfluous. In the gear steps I and II, too, the gear pump 21 is thus driven and maintains the pressure.

However, if the drive is stopped, the pressure generated by the gear pump 21 drops, and in the next starting operation, the starting step A is again available.

FIG. 4 shows a third embodiment of a drive device 39 according to the invention which is also provided with the starting step A of FIGS. 2 and 3 which functions as described, so that it does not have to be explained again.

The drive device 39 is moreover provided with gear members of a continuous transmission over a gear range B. The gear range B includes a commercially available chain converter 40 with a first chain wheel 41, a second chain wheel 42 and a chain 43 connecting them both. The first chain wheel 41 contains engaging and disengaging hubs 41a, 41b and is seated on the output shaft 12 over an overrunning clutch 44, the overrunning clutch 44 being preferably designed as an overrunning clutch comprising clamp bodies.

The second wheel 42 contains spring-loaded engaging and disengaging hubs 42a, 42b and is seated on another bypass shaft 45 with transmission of motion, which shaft is driven by the first gearwheel 13 via a cylindrical gear 46, the cylindrical gear 46 ensuring that the wheels 41, 42 are rotated in the same direction. The cylindrical gear 46 furthermore contains a gearwheel 47 which is seated on the bypass shaft 45 and drives a gear pump 21 of a gear limitation device 20 in the manner described above. The proportional valve of the gear limitation device 20 of the drive device 39 permits the switching on of the chain converter 40.

After the drive has been switched on, the drive device 39 is also driven first in the starting step A in the starting operation via the input shaft 11 until the pressure delivered by the gear limitation device 20 is sufficient for switching on the chain converter 40 automatically or by the driver, e.g. via the hydraulic system of the tractor 10 or a power set. In the starting step A, the output shaft 12 is driven at a speed at which the overrunning clutch 44 is not engaged. Thus, in the starting step A, the output shaft 12 does not drive the wheel 41 of the chain converter 40.

In contrast, in the starting step A, the gear pump 21 is driven via the cylindrical gear 46 and the gearwheel 47 and builds up the pressure necessary for switching on the chain converter 40. If the chain converter 40 is engaged with the output shaft 12 via the overrunning clutch 44, the speed can be continuously changed by relative motions of the hubs 41a, 41b or 42a, 42b, respectively, in the whole gear range B and with approximately the transmission ratios and speeds as in the drive device according to FIGS. 2 and 3, respectively.

FIG. 5 shows a fourth embodiment of a drive device 49 according to the invention which corresponds to the first to third embodiments except for the details described below, so that the same or comparable components are provided with the same reference numerals and are not explained again. The fourth embodiment of the drive device 49, too, contains a starting step A with a drive via the input shaft 11, the first gearwheel 13, the second gearwheel 14, the overrunning clutch 16, the bypass shaft 15, the third gearwheel 17 and via the fourth gearwheel 18 to the output shaft 12.

Furthermore, the drive device 49 contains a continuously variable gear range B which contains a differential gear 50 in this embodiment. The differential gear 50 contains a sun gear 51 which is fixed to the input shaft 11. The sun gear 51 is provided with a radial gear rim 51a and meshes with two planet gears 52a, 52b which have an identical design and are mounted about axes of rotation extending perpendicularly to the drive shaft 11 in a circumferential surface of a wheel-like support 53. The support 53 is connected with the fourth gearwheel 18 and thus with the output shaft 12 via a second overrunning clutch 54. Here, too, the overrunning clutch 54 can preferably be an overrunning clutch comprising clamp bodies.

The planet gears 51a, 51b furthermore mesh with a gear rim 55a of an adjustment gear 55, the gear rim 55a corresponding to the gear rim 51a of the sun gear 51. Another toothing 55b is provided at the adjustment gear 55 with which a pinion 56 meshes which is driven via a motor 57, preferably a hydraulic motor. By means of the motor 57, via the pinion 56 the adjustment gear 55 can be blocked or released and it can be actively driven in the same direction or in a direction opposite to the sun gear 51 at various speeds.

The starting step A of the fourth embodiment of the drive device 49 according to the invention operates as described above, i.e. the drive is effected, by bypassing the planetary gear 50, via the first gearwheel 13, the second gearwheel 14, the overrunning clutch 16, the bypass shaft 15, the third gearwheel 17 and via the fourth gearwheel 18 to the output shaft 12.

In the drive operation via the drive step A, the adjustment gear 55 is driven via the motor 57 in the same direction and approximately at the same speed as the sun gear 51 which is driven by the input shaft 11 1:1, such that the support 53 stands still or only rotates at a speed below the speed of the fourth gearwheel 18 in an operation in the starting step A, which results in a release of the overrunning clutch 54.

If now a shift into the gear range B is to be performed, the speed of the adjustment wheel 55 is reduced to below the speed of the input shaft 11 down to zero and the pinion 56 is blocked by the driver or automatically via the hydraulic system of the tractor 10 or a power set. In the process, the rotation of the support 53 is increased until the overrunning clutch 54 is engaged and the overrunning clutch 16 is released. If the adjustment gear 55 is blocked, the differential gear 50 drives the output shaft 12 with a gear ratio which results from the ratio of dimensions between the sun gear 51 and the planet gears 52a, 52b. Preferably, the ratio of dimensions between the sun gear 51 and the planet gears 51a, 51b is adjusted such that the output shaft 12 is driven at the desired speed for the mixing operation with the adjustment gear 55 being blocked.

For the metering out operation, for which a higher speed is desired, the adjustment gear 55 is driven via the pinion 56 by the motor 57 in a direction opposite to the sun gear 51 which increases the speed of the output shaft 12 up to the desired metering out speed.

The values for the transmissions and speeds correspond to the values already described with reference to the above embodiments.

The gear ratios of the gearwheels can be selected such that the adjustment range of the motor 57 is relatively low and high speeds of the pinion 56 and high torques acting on the differential gear 50 are avoided.

Furthermore, in the drive device 49, a pump could be provided which permits a shifting of the gear independently of the hydraulic circuit of the tractor analogously to the gear pump 21 of the previous embodiments. This pump could, for example, take over the control of the motor 57.

In order to further reduce the necessary speed range of the motor 57, in FIG. 6, a fifth embodiment of a drive device 59 according to the invention is shown. The drive device 59 only differs from the drive device 49 by a clutch 60, in particular a multi-plate clutch, which directly, i.e. 1:1, connects the input shaft 11 with the output shaft 12 via the support 53. In the process, the pinion 56 idles.

The gear limitation device 20 of the first to third embodiments is provided in the drive device 59, which again contains a gear pump 21 and a non-depicted proportional valve with which the clutch 60 can be shifted in the already described manner. In this embodiment, thus the motor 57 only has to vary the mixing speed, so that a relatively inexpensive motor with a small speed range can be employed.

In variation to the described and drawn embodiments, the drive device according to the invention can also be used for driving other apparatuses where a starting step A is reasonable, that is, for example, in combine-harvesters, chaff cutters, or the like. The gears of the drive devices can be modified. For example, the toothed gearings can be replaced by other types of gears. The gear limitation device can also be realized by external sources, e.g. via the tractor by a control program (ISOBUS system) or a separate unit, by determination of the number of revolutions or of the amount of torque.

1. Drive device for a mixing tool of a food mixer with a gear comprising an input shaft, an output shaft, gear members for driving the output shaft at a low and at least one higher speed, as well as a shifting device for shifting between the speeds, a starting step with a low speed being designed for a starting operation, the starting step containing an overrunning clutch via which a gear member can be connected with the input and the output shafts in the starting step with transmission of motion and which can be released at the higher speed.

2. Drive device according to claim 1, characterized in that the overrunning clutch can be released by rotating the output shaft.

3. Drive device according to claim 1, characterized in that the overrunning clutch is an overrunning clutch comprising clamp bodies.

4. Drive device according to claim 1 characterized in that the shifting device contains a hydraulic clutch for shifting between the starting step and the higher speed.

5. Drive device according to claim 1, characterized in that the input shaft can be directly connected with the output shaft via a clutch for shifting to a higher speed.

6. Drive device according to claim 1, characterized in that the shifting device contains a gear limitation device which prevents a shifting to the higher speed before the starting operation.

7. Drive device according to claim 6, characterized in that the shifting device contains a hydraulic clutch for shifting between the starting step and the higher speed, and that the gear limitation device comprises a hydraulic fluid pump and a proportional valve in the shift circuit of the hydraulic clutch, the pump being driven in the starting step for building up pressure in the hydraulic fluid.

8. Drive device according to claim 1, characterized in that the starting step comprises a first gearwheel fixed to the input shaft and meshing with a second gearwheel provided with the overrunning clutch and seated on a bypass shaft, and that the bypass shaft is connected with the output shaft with transmission of motion.

9. Drive device according to claim 1, characterized in that the starting step and a gear step for a higher speed are provided.

10. Drive device according to claim 1, characterized in that the starting step and at least a first and a second gear step for higher speeds are provided, by which the overrunning clutch of the starting step can be released, and wherein each of the first and second gear steps comprises gear members which can be connected with the input and output shafts each via a clutch.

11. Drive device according to claim 10, characterized in that the first higher gear step comprises a first gearwheel connected with the input shaft with transmission of motion and meshing with a gearwheel seated on a bypass shaft, and that the bypass shaft can be connected with the output shaft via the clutch.

12. Drive device according to claim 11, characterized in that the gearwheel seated on the bypass shaft is connected with the bypass shaft via another overrunning clutch with transmission of motion.

13. Drive device according to claim 1, characterized in that the starting step and a continuously variable gear range for higher speeds are provided, by which the overrunning clutch of the starting step can be released and which comprises a gear member which can be connected with the input and output shafts via another overrunning clutch and can be released in the starting step.

14. Drive device according to claim 13, characterized in that the gear range comprises a chain converter, one wheel of the chain converter being provided with the other overrunning clutch.

15. Drive device according to claim 14, characterized in that the starting step and a continuously variable gear range for higher speeds are provided, by which the overrunning clutch of the starting step can be released, and which comprises a gear member which can be connected with the input and output shafts via another overrunning clutch and can be released in the starting step.

16. Drive device according to claim 13, characterized in that the gear range comprises a differential gear.

17. Drive device according to claim 16, characterized in that the differential gear contains a sun gear connected with the input shaft, at least one planet gear, a support connected with the output shaft via the other overrunning clutch and a motor with which the speed transmitted to the output shaft can be varied.

18. Drive device according to claim 17, characterized in that the motor acts upon an adjustment gear which meshes with the planet gear.

19. Drive device according to claim 18, characterized in that the planet gear is mounted in the support with an axis of rotation perpendicular to the axis of rotation of the sun gear, and the adjustment gear meshes with the planet gear at a side of the support opposite to the sun gear.

20. Drive device according to one of claims 13 to 19, characterized in that a hydraulic system of a tractor or a power set are provided for shifting in the gear range.
